(19) United States
(12) Patent Application Publication
(10) Pub. No.: US 2005/0219459 A1
(43) Pub. Date: Oct. 6, 2005

(54) Beautiful eye

(76) Inventor: Kazutora Yoshino, Eden Prairie, MN (US)

Correspondence Address: KAZUTORA YOSHINO, 7227 Divinity Ln., Eden Prairie, MN, 55346, US

(21) Appl. No.: 11/132,129

(22) Filed: May 19, 2005

Related U.S. Application Data
(63) Continuation-in-part of application No. 10/653,553, filed on Sep. 2, 2003.
(63) Continuation-in-part of application No. 11/066,940, filed on Feb. 28, 2005.

(51) Int. Cl. G02C 1/00

(52) U.S. Cl. 351/160 R

(57) ABSTRACT

Beautiful eye is this invention. Holographic color patterns are put on contact lens. Also, this invention is to make beautiful eye. Also, this invention is to make better society for food. Also, this invention improve the society by having better medical cares with medicine generation including bio-informatics' operation/control.

### CROSS REFERENCE TO RELATED APPLICATION

This is a continuous-in-part application of
U.S. application Ser. No. 10/653,553,
U.S. application Ser. No. 11/066,940,
Doc. Number: KYU01E0101 (yoshino time machine), and
Doc. Number: KYU001E002 (security up).

### FEDERALLY SPONSORED RESEARCH

Not Applicable

### SEQUENCE LISTING OR PROGRAM

### BACKGROUND OF THE INVENTION

1. Field of the Invention

Applicant found that there are many problems in the Christian society asking who is more beautiful than the others. This might not be a problem, because it is all subjective, philosophically speaking . . . For example, people start getting together with same color eyes, and same color hairs, and so on. It is not too bad as far as conservation of phenotype, population-genetics-wise. Yet, information or communication-wise, it is not optimizing the genetic algorithm of its own for such behavior, as far as applicant may consider, which could be verified by certain witness of people who experienced such in their life.

Yet, is there any way that people look like as they like to be appearing? So, how they genetically look doesn't really matter for their life. And they may be accepted to different kind of people more smoothly?

Also, applicant found that every time, applicant have egg/meat, feel sad to animal(s), as some may think in the similar way.

And applicant starts considering if there are any ways to produce food/meat directly in the taste food appreciators such as applicant like without killing animals or hopefully plant/fruit. Of course, we need essential nutrition. Could we find the way to get food without killing the others? Hopefully, we like to have inexpensive and high quality food, as far as applicant thinks. There are so many people who are starving even now days, which is another sad thing.

Not only that, applicant found there are many people go to heaven while they had good actions in their life though there are not enough organs such as heart/lung/blood to implant if necessary to be replaced. When some body who people love, are in such situation, what do you do? Do we just accept as it is?

Yet, do we need some registration with government for changing their future, changing the genetic future, or replacement/improvement of organs, memory, (experience) for security reasons? This invention is disclosed with constraint that user shall not deceive the others and users shall not damage the others based on such disguise.

2. Description of the Prior Art

The contact lens has colors now days. It can be switched by users. Yet, some brown eyes people like to have colorful eyes. But when brown eyes people wear these color contact lens, it looks quite unnatural from the perspective of applicant. This is because, the iris looks on the surface of the lens, and color refection looks very unnatural.

Also, eggs and meat now days are produce by chickens and by killing animals usually speaking. It is not too nice to animals, from applicant point of view.

### SUMMARY OF THE INVENTION

So, in this invention, applicant loves to disclose the device, method and manufacturing method to produce the changing or improving the part or entire body of organ or looking.

This invention enables for users to choose the desired future, to create better self-estimate, hopefully.

Virtual field generation means such as holographic color contact lens are shown. This enables for observer to look the eye color as if it is real due to the depth, patterns, reflection and colors of the iris. CAD/CAM may be used for eye pattern design. Or 3D scanner is used for designing the patterns and for checking of the pattern for identification. 3D display and 3D input device may be used for eye pattern so that eye pattern changes by the choice of or as desired by the user(s).

Alternatively, artificially, eye, with desired color and pattern, is made in pattern pellet. The example of pattern pellet is patterned pellet, step pellet, pattern-printed pellet and structured pellet.

Considering of entropy and free energy in eco-system, solar energy may be one of best choice to make these devices for manufacturing.

Genetic sequence, SNP, master key genetic sequence, and homeotic gene sequence, are used for the improvement and growth of the cells.

The system of invention has heat conducting and insulating and concealing walls that confine the characters such as chemicals, energy and entropy to be kept well for the purpose of production.

### OBJECTIVES AND ADVANTAGES OF THE INVENTION

First, the objective of this invention is to change feature to more desired feature, with hopefully inexpensive cost.

Second, it creates food massively without killing animals with inexpensive cost.

Third, it creates or improves certain organs with inexpensive cost.

### BRIEF DESCRIPTION OF THE DRAWINGS

### DESCRIPTION OF SPECIFIC EMBODIMENT

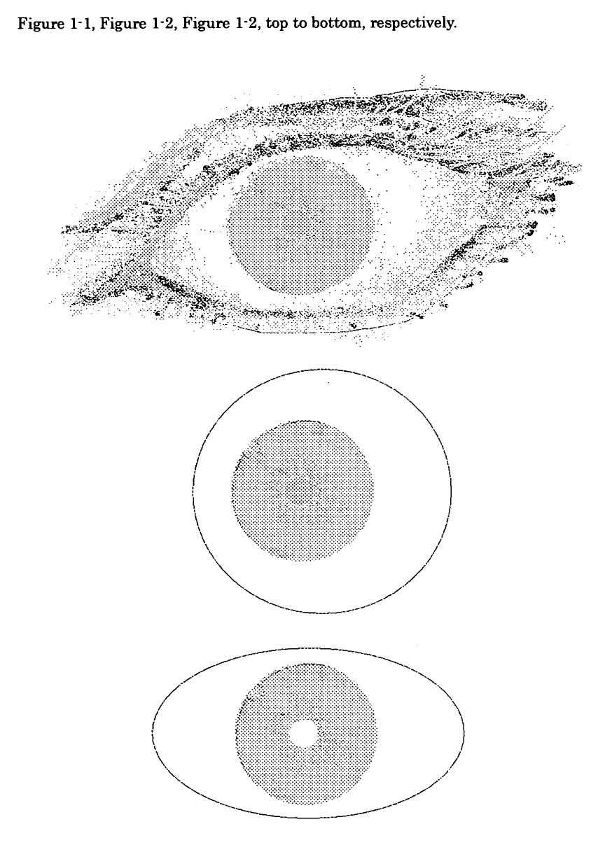

FIG. 1-1 shows the example diagram of beautiful eye.

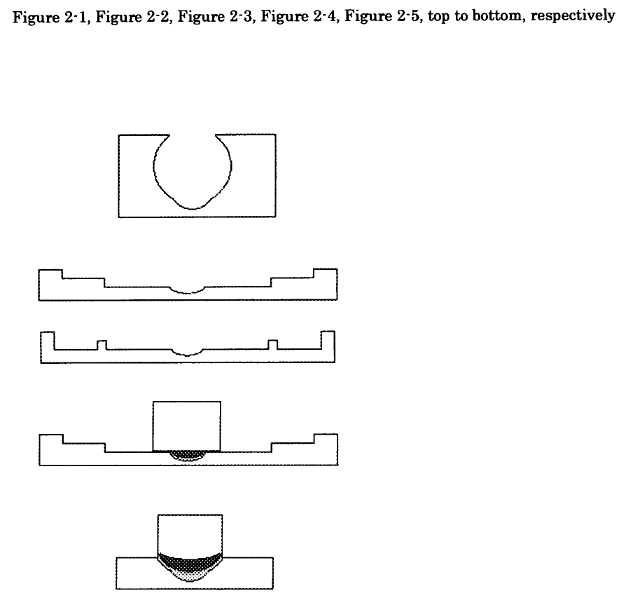

FIG. 1-2 shows the example diagram of beautiful eye artificial.

FIG. 1-3 shows the example diagram of beautiful eye of holographic contact lens.

As more examples,
beautiful eye may be
pin holes contact lens,
hologram contact lens,
color hologram contact lens,
curvature surface with circle/oval-like shape color hologram contact lens,
curvature surface with circle/oval-like shape color hologram contact lens with density & gravity control for direction,
color hologram contact lens with QR code and/or bar code embedded.

FIG. 2-1 shows the example diagram of container/pellet (side view). This shape is suitable for eye ball.

FIG. 2-2 shows the example diagram of pattern (structure) pellet such as stepping pellet. (side view).

Based on the growth of cell(s), user may add more proper chemicals, step by step for example.

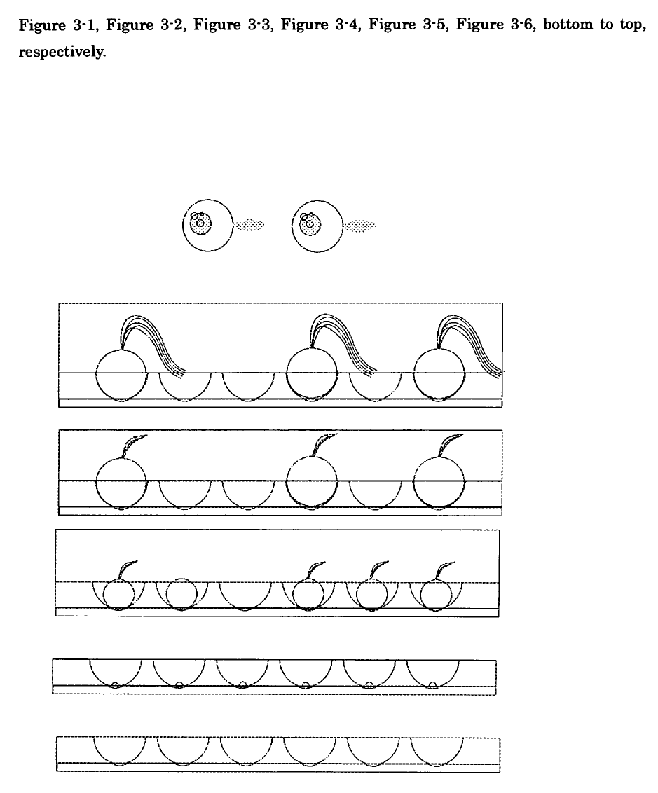

FIG. 2-3 shows the example diagram of pattern (structure) pellet such as patterned pellet (side view).

FIG. 2-4 shows the example diagram of (structure) pellet with printing and/or pressing action added.

FIG. 2-5 shows the example diagram of container with special lid for structuring material.

Material may be combinational DNA, with desired SNP embedding to ES cell of eyes. Designing the phenotype and genotype of desired feature may be at first. It may be done using informational technology, computer graphics, computer design and/or by artistic method. The corresponding co-relationship between the phenotype and genotype shall e made as data base. Based on data co-relation ship, user may choose the best sequence(s) fitting on the data matching and analyzing method using method such as S.V.D. or closest fit of sequence. Expectation value of enzyme, protein, expression, and/or features may be calculated. Based on the amount of enzyme and protein produced, phenotype may be expected for example. Natural expectation of phenotype may be displayed for simulation. Neural-network, genetic algorithm may be used for expectation and optimization. Delta method and delta operation for the how it is and how it like to be may be used as alternative. As the difference of original phenotype, new phenotype, original genotype, new genotype is used for delta calculation to make calculation more efficient.

This method may be used for organic material such as organism, eye, heart, lung, brain and biological entity such as DNA, RNA, m-RNA, protein, prion, nanobe, virus, cell, bacteria, plant, egg, meat, animal, human, whale, dinosaur and future bionoid (artificial creature/artificially created bio entity).

FIG. 3-1 shows the example diagram of patterned container.

FIG. 3-2 shows the example diagram of patterned container/pellet with first cell means/embryos of egg are put in sections. Before or after, bio-chemical materials are put to these containers.

FIG. 3-2 shows the example diagram of patterned container/pellet with growing eye balls.

FIG. 3-3 shows the example diagram of patterned container/pellet with growing eye balls. Eye ball may be implanted to patient in this stage as alternative.

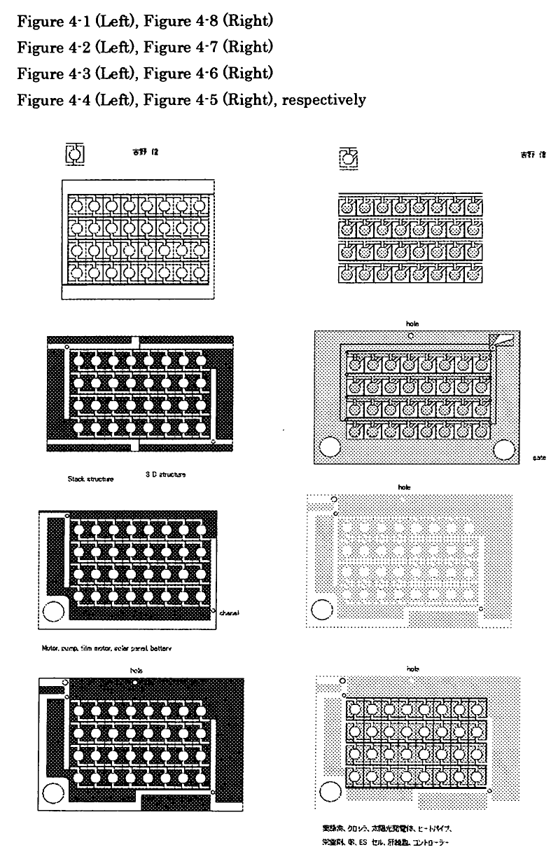

FIG. 3-4 shows the example diagram of patterned container/pellet with growing eye balls.

FIG. 3-5 shows the example diagram of patterned container/pellet with growing eye balls.

FIG. 3-6 shows the example diagram of grown up eye ball.

This process may be used for eye manufacturing. Alternatively, eye(s) may be implanted while it is still growing. Alternatively, color enzyme/protein/gene sequence may be produced and embedded to base to target. Alternatively, lens cells may be grown up.

Color living contact lens, color contact lens, color holographic contact lens, color eye(s) may be useful for eye sight correction, eye color modification, eye fashion, eye fusion, eye blind, and eye color blind. Octopus-like eye color change may be created implanting enzyme, protein, gene sequence of color-element of octopus to eye color sequence.

FIG. 4-1 shows the example diagram of bio-system. In bio-system, system-entity means such as proper material, trans-entity, information transportation, cell, cells, bio entity, bio-chemical entity, chemical entity, protein, enzyme, DNA, RNA, ribosome, embryo, sugar, water, nutrition, nutritious material, nutritious liquid may grow, diminish, and/or be converted. Other commonly known cellular biological component may be used such as chlorophyll, inorganic phosphate, adenosine triphosphate, adenosine di-phosphate, nucleic acid, deoxyribonucleic acid, ribonucleic acid, ribosome, golgi, prion, nanobe, virus, bacteria, cell, biological fluid, nucleus, biological component, cellular components, membranous organelles, plasma membrane cytoplasmic membrane, plasmalemma, nucleus, nuclei, nucleolus, nucleoli, mitochondrion, mitochondria, chloroplast, endoplasmic reticulum, smooth endoplasmic reticulum, rough endoplasmic reticulum, vacuole, peroxisome, leucoplast, gogi vesicles, lysosome, dicryosome, protein, protein body, contractile vacuole, food vacuole, food, nutrition, glyoxysome, desmosome, plasmodesmata, cytoskeleton, centriole, polysome, cell wall.

These are environmental matrix of system-entity such as cell(s) and embryo(s). It may act like the nuclear of cell for operations such as DNA operations. On the wall of unit, diamond coating may be done, alternatively, ribosome, and more cellar biological components are embed/attached on or in the wall. Necessary nutritional liquid may run through or stop in the units with proper timing.

FIG. 4-2 shows the example diagram of bio-system. This type is run-though or stop matrix. These matrix may be put aside and/or stack up to each other.

FIG. 4-3 shows the example diagram of bio-system having feed forward and feed backward. Circular circuit may be used. And inter-conversion may be occurred in the middle of feeding back and/or feeding forward. It may have third dimensional connector to different/same/similar units, as alternative.

FIG. 4-4 shows the example diagram of bio-system having hole(s). These may be hanged in so that embryo may be grown up with gravity. It may help in the way that they may get to be feed better with density control of nutritious liquid and growth algorithm of embryo itself relative to gravitational field. If it is in space, the inertia may be executed to these units for the maintenance/growth of embryos/cells.

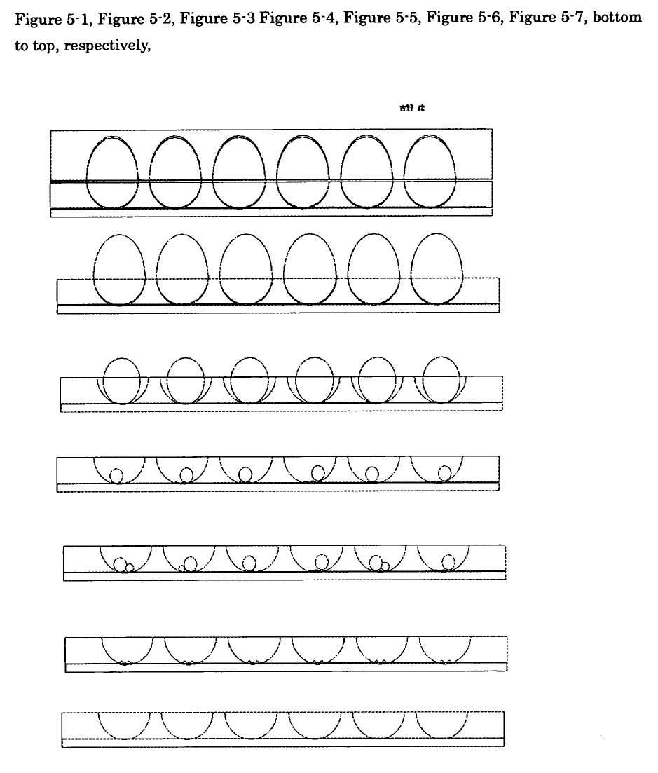

FIG. 4-5 shows the example diagram of bio-system having plurality of different patterns on pellet/container.

FIG. 4-6 shows the example diagram of bio-system having plurality of different patterns on pellet/container alternatively with photo-synthesizer.

FIG. 4-7 shows the example diagram of bio-system having plurality of different patterns on pellet/container with solar panel, hydrogen & oxygen fuel cell alternatively together with batteries.

FIG. 4-8 shows the example diagram of bio-system having plurality of different patterns on pellet/container having more chemical (food) added in the middle of feed back circuit.

It is example of mass production model for bio-system base. These are manufactured inexpensively by printing, reprinting, adding and subtracting. Multiple network units are combined for the proper purpose to produce desired material(s). Alternatively, feed-back and feed-forward, feed-convert, feed-combined system is embedded. They may be stacked to multi-layers.

System entity means such as stem cell(s), ES cell(s), Artificial Code Sequence(s), Ribosome(s), DNA(s), RNA(s), Prion(s), Nanobe(s), Nanoid(s), Bion(s), Bionoid(s), Medicine(s), ES cell for eye lens/eye, plastic, nutrition, m-RNA, protein, cells, cell components and/or young cells are put with or without printing to or into the container or wall of container. Cells/ribosome may be anchored to walls if desired.

It is used for the multiplication of cell in cell division, metabolism, and synthesis analysis.

Alternatively these patterns may be used for lens making. Wall(s) and etching of wall(s) as the curvature may be used for different focal length.

FIG. 5-1 shows the example diagram of container/pellet that has sections within which there are small sections.

FIG. 5-2 shows the example diagram of cell or embryo of egg is put in small section each before or after its nutrition such as ATP, protein, enzyme is put.

FIG. 5-3 shows the example diagram of cells or embryos start growing having starting signal/chemical, alternatively.

FIG. 5-4 shows the example diagram of choice making process. The best cell or embryo is chosen. The rest may be transfer or something else.

Sensors are used for which cells/embryos/eggs are growing most/best. The reason why there are a few such as 4 small sections is because some cells or embryos grow and the other cell or embryos doesn't grow.

Neural perspective algorithm may be used for judging/deciding which cell or embryo grow best in each section.

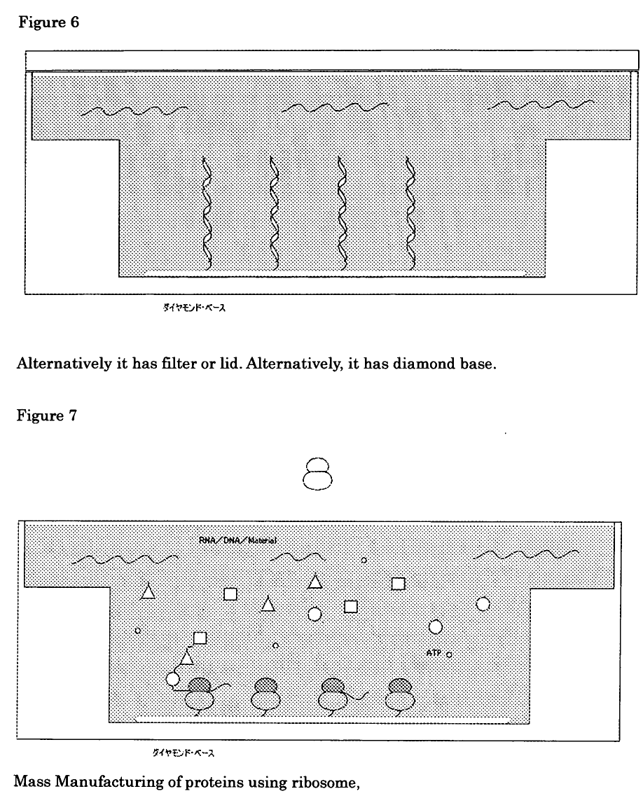

FIG. 5-6 shows the example diagram of growing eggs. Alternatively, light and/or heat may be applied.

FIG. 5-7 shows the example diagram of grown eggs with cover put on the eggs.

This example bionoid manufacturing. Bionoid is the artificially created bio-entity. Here egg is bionoid. These sequence shows the diagram of mass production of eggs as Bionoid and this enables the manufacturing of eggs much more inexpensive.

FIG. 6 shows the example diagram of mass production of nucleic acid. Multiplying DNA/RNA by cooling and heating. The precursors of DNA and RNA are added as part of chemicals or nutrition. Bio-components may be added to create virtual cell(s). It may be used for simulation including analysis of bio-chemical materials.

In Alternatively it has filter or lid. Alternatively, it has diamond base.

FIG. 7.

Mass Manufacturing of proteins using ribosome, ATP and m-RNA. This is useful for biomedical production. The ribosome is anchored, quasi-fixed by jelly-like material or freely moving (in liquid). The anchored ribosome is shown. The ribosome accept the m-RNA and produce proteins using the energy saved in ATP. The entropy of system is controlled by the environment given from outside and inside. Monosome, and Polysome may be considered as terms for the combination of ribosome and m-RNA.

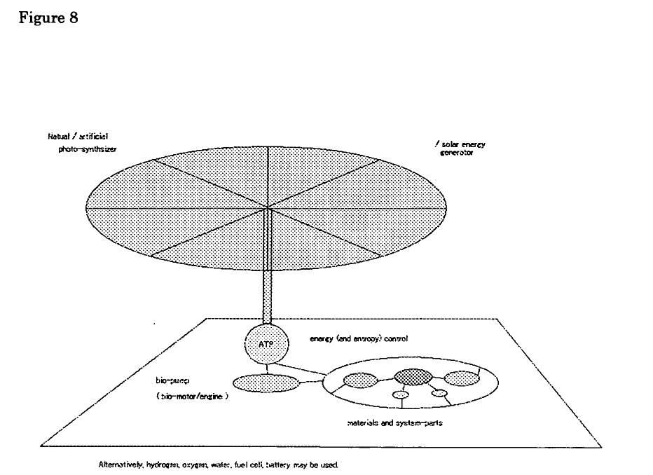

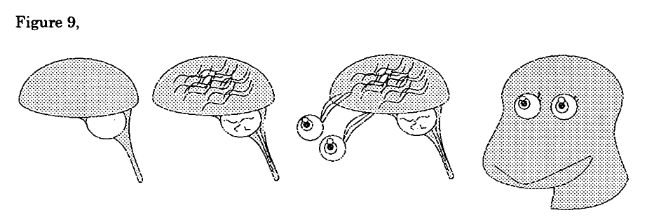

FIG. 8 shows the diagram of bio-system. It has photo-synthesizer with ATP generator. It produces ATP and distribute them to proper sub units of system at proper location and proper time. ATP energy and entropy controller for eco-unit are alternatively added.

Alternatively solar energy generation such as solar panel embedded. Photons are received to silicon and/or chloroplast/chlorophyll of panel. It produces electricity by photo-electric effect. It is converted to electrical energy or ADP+energy−>ATP. ADP and ATP are circulated for proper flow as the exchange of energy. Alternatively, mitochondrion, mitochondoria may be alternatively used in the system where ATP is created from glucose or nutritions. Christa will help the producing of ATP in this case. Inorganic phosphate may also be used. Combination of (artificial) chloroplast and mitochondrion may be used.

This may be used for supporting bio-sphere. Or it may be used for creating bion, which is bio-chemical nutritious food.

FIG. 9-1 shows the example diagram of bionoid. Artificial container for brain is prepared. Diamond, silicon, materials are used for the surface. On an in the container, structures and jells (nutrition) for neurons or artificial neurons is prepared.

FIG. 9-2 shows the example diagram of bionoid. Neurons/artificial neurons are growing up in the artificial brain.

FIG. 9-3 shows the example diagram of bionoid. Eye(s), artificial eye(s) and other organs are added to artificial brain.

FIG. 9-4 shows the example diagram of bionoid. Cover is put. This may be used as a partner mascot.

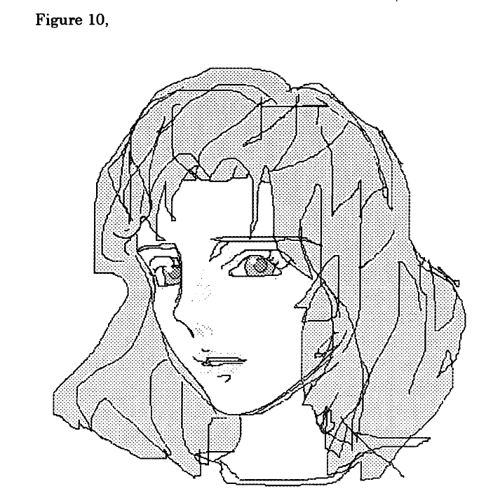

FIG. 10 shows the diagram how applicant views the beauty.

1. The invention of beautiful eye means comprising group comprising
pin holes contact lens,
hologram contact lens,
color hologram contact lens,
curvature surface with circle/oval-like shape color hologram contact lens,
curvature surface with circle/oval-like shape color hologram contact lens with density and gravity control for direction,
color hologram contact lens with quality reading code embedded,
two or three dimensional display with eye color,
photon input or output system with eye color, artificially created eye, and
artificial eye,
organ,
biological entity,
biochemical entity, and
bioinformatical entity.

2. In the claim of 1, wherein said beautiful eye is manufactured in the process comprising group comprising
process to put designed pellet means,
process to put proper chemical and bio-chemical of material,
process to transform said proper material to desired material,
alternatively, process to modify or improve said desired material to more desired material by transforming said desired material,
alternatively, process to modify or improve said desired material to more desired material by adding three dimensional patterns,
alternatively, process to modify or improve said desired material to more desired material by adding more nutrition and proper component,
alternatively, process to modify or improve said desired material to more desired material by punching said desired material,
alternatively, process to modify or improve said desired material to more desired material by removing said desired material,
alternatively, process to modify or improve said desired material to more desired material by assembling said desired material,
alternatively process to repeat said process.

3. The invention of system of growing cell means comprising group comprising
system entity means such as cell means such as cell, cells, stem cell, es-cell, embryo, embryo of egg, and egg,
chemicals, adenosine-tri-phosphate, carbon-hydrate, proteins, fat, fiber, chemical supplier, belt conveyer, carrier, egg sensor, egg verifier, egg choicer, package, sperm, love, egg and sperm combining unit, food, nutrition, liquid, solid, gas, plasma, hormons, immune, blood, white cell, nucleic acid, ribosome, protein, precursors, precursor of proteins and nucleic acid, deoxyribonucleic acid, ribonucleic acid, m-ribonucleic acid, nucleic sequence, artificial nucleic sequence, neural networks, brain,
bio-system, bio-circuit, bio-circuits with feed-forward and feed-back system, bio-circuit with multiple units, bio-net works,
solar panel, photo-synthesis unit, adenosine-tri-phosphate generator or supply unit, energy supply unit, entropy supply unit, hydrogen supply unit, oxygen supply unit, hydroid supply unit,
incubator, heater, lamp, tube,
light, water, materials, temperature, air, gravity, music, scent, mood, body,
base, diamond base, pellet, container, body, robot, genetics checker,
controlling system, and
yoshino sytem.

4. In the claim of 3, the process of making said growing cell means or egg system comprising group comprising
process to put package to conveyer, wherein said package has plurality of section at the bottom, and said section has plurality of small sections,
process to put proper chemicals to grow said cell means or said embryos of eggs,
process to put cell means or embryos of eggs to said plurality of small sections,
process to start sending signal or biochemical materials to start growing said cell means or embryos of eggs,
process to grow said cell means or embryo of egg,
process to complete growing said cell means or embryo of eggs,
process to sense and verify growth of cell means or embryo at the bottom of said package,

5. The design of beautiful eye pattern means comprising group composing
color of red, green, blue, combination color of red, green, blue,
yellow, cyan, magenta, combination of yellow, cyan, magenta,
Purple, gold, silver, brown, rainbow color, bits of all kinds of colors,
line combination of colors, dot combination of colors, amorphous combination of colors, emulation combination of colors, emulous combination of colors, imitational combination of human eyes, and
patterns to create three dimensional virtual field with reflection or emission of light.

6. The bioinformatical system comprising group comprising
program to find the closest set of gene sequence to desired phenotype or expression features based on co-relation data base made, between genotype and phenotype,
program to find the expectation feature of expression,
program to find the expectation feature of expression based on delta method,
program to determine the best genetic sequence to embed to cell means or embryo of egg as the best fit of genotype and phenotype,
program to combine said genetic sequence to base genetic sequence in cell means or embryo of egg, for real or for simulation, and
program to grow said cell means or embryo of egg, for real or for simulation.

7. In the claim of 6, wherein said bioinformatical system comprising plurality of said sequences and said programs.

8. The system of artificial system entity or creature comprising group comprising
artificial brain container, artificial neurons, artificial eye balls, artificial mouse, artificial ears, artificial nose, artificial organs, robot,
brain container, neurons, eye balls, mouse, ears, nose, organs, heart, lung, body, stomach, diaphragm, hand, finger, arm, leg, head,
chlorophyll, inorganic phosphate, adenosine triphosphate, adenosine di-phosphate, nucleic acid, deoxyribonucleic acid, ribonucleic acid, ribosome, golgi, prion, nanobe, virus, bacteria, cell, biological fluid, nucleus, biological component, cellular components, membranous organelles, plasma membrane cytoplasmic membrane, plasmalemma, nucleus, nuclei, nucleolus, nucleoli, mitochondrion, mitochondria, chloroplast, endoplasmic reticulum, smooth endoplasmic reticulum, rough endoplasmic reticulum, vacuole, peroxisome, leucoplast, gogi vesicles, lysosome, dicryosome, protein, protein body, contractile vacuole, food vacuole, food, nutrition, glyoxysome, desmosome, plasmodesmata, cytoskeleton, centriole, polysome, cell wall,
and aritificial components of above components.
